(19) United States
(12) Patent Application Publication
(10) Pub. No.: US 2002/0176617 A1
(43) Pub. Date: Nov. 28, 2002

(54) System and method for continuous integrity testing of a material web

(75) Inventor: John A. Simonetti, Thousand Oaks, CA (US)

Correspondence Address: Mr. Charanjit Brahma, PILLSBURY WINTHROP LLP, Suite 2800, 725 South Figueroa Street, Los Angeles, CA, 90017, US

(73) Assignee: PTI Advanced Filtration, Inc.

(21) Appl. No.: 09/862,683

(22) Filed: May 22, 2001

(51) Int. Cl. G06K 9/00

(52) U.S. Cl. 382/141

(57) ABSTRACT

A system and method for detecting defects in a porous material web or dense film applies differential pressure across the material web or film. The pores and defects in the material web or the defects in the dense film may be filled with a liquid. In embodiments of the invention, differential pressure may be applied using a vacuum roller or other vacuum pressure application device. When the differential pressure applied to the material web exceeds the bubble point pressure of a defect, the liquid within that defect may be removed. An image, such as a thermal or photographic image, of the material web is captured after the differential pressure has been applied across the material web or film. Removal of the liquid from a defect is indicated in the image, allowing defects to be detected.

### FIELD OF INVENTION

The present invention is related to manufacturing porous media and dense films, and particularly to a system and method for detecting a defect therein.

### BACKGROUND

It is often desirable to test porous media, e.g., filtration membrane media, or dense film for defects, such as enlarged or misshapen pores or holes. One non-destructive test commonly used to test for defects is known as the “bubble-point test.” As described in U.S. Pat. No. 5,064,529 to Hirayama et al. and U.S. Pat. No. 5,576,480 to Hopkins et al., the bubble point of a porous medium may be discovered by first impregnating the porous medium or dense film with a liquid (such as distilled water) and then forcing a gas through the porous medium at a known pressure. In the case of a filtration medium, this may be accomplished by mounting the filtration medium on a supporting body with inlet and outlet ends and immersing the filtration medium in a bath of the impregnating liquid while segregating the internal chamber of the supporting body from the liquid. The internal chamber of the supporting body may be supplied with fixed pressure or variable pressure gas from a gas source.

The pressure at which the gas forces the liquid out of a pore or defect in the porous medium or dense film is dependent upon the size of the pore or defect, the surface tension characteristics of the liquid in the pores or defects of the porous medium or dense film, and the wetting angle of the interface between the filter medium material and the pore/defect liquid. Their relationship may be ideally approximated for circular pores and defects according to Laplace's Law, i.e.,

P=2(γ cos θ)/r (I)

where P=the bubble point pressure, i.e., the point at which the gas expels liquid from the pore;

γ=a surface tension coefficient for the liquid in the pore or defect, which may depend upon the liquid and the porous medium or dense film material;

θ=the contact angle of the interface; and

r=the radius of the pore or defect.

As described by Laplace's Law (I), as the radius (size) of a pore increases, the bubble point pressure for the pore or defect will decrease. The bubble point can be visibly detected by the formation of gas bubbles on the submerged surface of the porous medium. The pressure at which gas is supplied at the internal chamber of the supporting body may be increased from an initially low value to precisely locate defects of various sizes. In such a testing procedure, the first bubbles will be visible at the largest defects.

Present systems for submersion testing of porous media and dense films, and particularly, filtration membranes, using the bubble point test have been ill-suited for continuous testing prior to forming large webs of the porous media or dense film into smaller elements that are formed around a supporting body. It is generally necessary to test smaller elements instead of continuous webs of porous media or dense films because liquid baths in which the porous media or dense film elements are submerged are of limited size and an internal chamber of limited size is needed to apply gas to an internal surface of the porous media element. Accordingly, when defects have been detected in a formed element, there has been little that can be cost-effectively done to repair the defect. Thus defective elements generally go to waste, increasing the overall cost of production of porous media and dense film products.

Alternatively, porous membrane and dense film elements are mounted, wetted and subjected to air pressure on one side (in the case of a cylindrical element, either the inner or outer surface of the element). Bubble point pressure is determined by measuring air flow downstream of the wetted filter element. As the air pressure applied is varied to exceed the defect bubble point pressure, the down stream air flow changes sharply, indicating that an unsuitably large defect is present somewhere within the element. These types of tests do not allow for the precise location of defects. Rather, they provide only information as to the suitability of an entire element for a particular application.

### BRIEF DESCRIPTION OF THE DRAWINGS

FIG. 1 depicts an portion of a defect detection system according to an embodiment of the present invention;

FIG. 2 depicts a vacuum roller that may be used in an embodiment of the invention;

FIG. 3 shows a captured image according to an embodiment of the invention; and

FIG. 4 depicts an alternative embodiment of the present invention including a post-processing device.

### DETAILED DESCRIPTION

Embodiments of the present invention relate to a system and method for detecting defects in porous media or dense films using a vacuum roller(s) and an automated vision system to perform a bubble point or similar integrity test. Embodiments of the system are capable of detecting defects in continuous webs of porous media or dense films, thereby allowing for the detection, marking and/or repair of defects prior to formation of the porous media or dense films into individual elements. The approach of the present invention may also reduce the sizes of liquid baths and amounts of liquid needed to perform defect tests.

Although the following description focuses on embodiments of the present invention for locating defects in porous material webs, it will be readily understood that the invention may be used for detecting defects in other types of materials including dense films and can be used for detecting any defects that can be characterized by a bubble point pressure. Accordingly, although such a film will not have “pores,” a dense film should be treated as a type of “material web” for all other purposes in the following discussion. Furthermore, the term “material web” is also intended to include woven and non-woven mats.

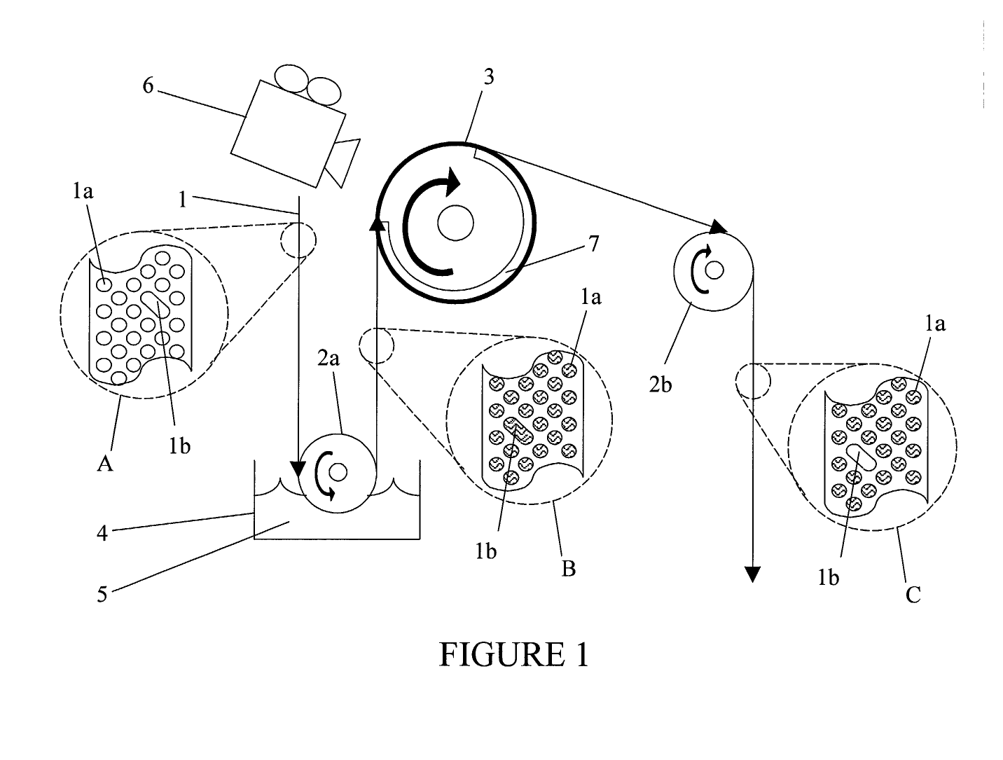

FIG. 1 illustrates a defect detection system according to an embodiment of the present invention. The material web 1 may be a continuous web of porous medium material (as shown in FIG. 1) or a dense film. The material web 1 may have a specified desired bubble point pressure, e.g., 100 mm Hg. In the case of a dense film, the desired bubble point pressure may be equivalent to the pressure at which the material would be torn or ruptured.

In the porous material web 1 shown in FIG. 1, a properly formed pore 1a (shown in magnified view A, B, and C of a portion of the face of the material web 1) may, therefore, have a bubble point pressure substantially equal to the desired bubble point pressure of the material web 1. A defect 1b (shown in magnified views A, B, and C) in the material web may have a bubble point pressure that is substantially lower than the desired bubble point pressure, which may indicate that the defect 1b is significantly larger than a properly formed pore 1a and, possibly, unsuitable for an application in which the porous medium is to be used. For example, in a filtration application, the porous medium may be needed to filter out particles of a size smaller than the defect 1b.

The material web 1 may be wetted with a liquid 5 in a liquid bath 4 so that the liquid fills substantially all of the pores 1a and defects 1b of the material web 1 (as shown by the hatching in magnified view B). To wet the material web 1, the material web 1 may begin with the pores 1a and defects 1b empty of the liquid 5. The material web 1 may be fed around a first roller 2a, which may be wholly or partially (as shown in FIG. 1) submerged below the surface of the liquid 5 in the liquid bath 4. Alternatively, in a dense material web 1, only defects 1b may be filled with liquid 5 during the wetting process.

In alternative embodiments of the system, multiple rollers may be wholly or partially submerged below the surface of the liquid 5 in the liquid bath 4 and the material web 1 may be fed around the multiple rollers to lengthen the amount of time that the material web 1 is submerged in the liquid 5 to allow the liquid 5 to enter the pores 1a and defects 1b. In embodiments of the invention, the first roller 2a may also be a vacuum roller and vacuum force may be applied to the material web 1 by the first roller 2a to draw the liquid 5 into the pores 1a and defects 1b.

The wetted material web 1 may then be fed to a vacuum roller 3. The arrows in FIG. 1 indicate the direction of feed of the material web 1 and the direction of rotation of the vacuum roller 3, the first roller 2a and a second roller 2b. The wetted material web 1 may be held in contact with the vacuum roller 3 by vacuum pressure, gravity, tension in the material web created by the positioning of the first roller 2a and second roller 2b and/or some other force. Where the material web 1 contains very small pores, fluid retained in the membrane pores due to capillary forces may minimize or prevent air flow through the material web 1. This allows vacuum pressure to build up so as to hold the material web 1 in contact with the vacuum roller 3 as the vacuum roller 3 turns. Similarly, vacuum pressure may hold a dense film material web 1 against the surface of the vacuum roller 3. A shield 7 may be mounted inside (as shown) or outside the vacuum roller.

When vacuum pressure from the vacuum roller 3 is applied to the material web 1, the liquid 5 may be drawn out of the pores 1a (for a porous medium, as shown in FIG. 1) and defects 1b of the material web 1 (as shown in magnified view C) by the differential pressure created by the vacuum. Whether the liquid 5 is drawn out of a particular pore 1a or defect 1b may depend upon the size and shape of the pore 1a or defect 1b, the contact angle between the solid material encircling a pore 1a or defect 1b in the material web 1 and the liquid in the pore 1a or defect 1b, and the amount of differential pressure created across the material web 1 by the vacuum roller 3. The liquid 5 removed from the material web 1 may be drawn into the vacuum roller 3 and subsequently drained away.

The amount of differential pressure applied across the material web 1 may be set according to the sizes and shapes of defects whose detection is desired, the requirements for a particular application of the material web 1, or other factors. In embodiments of the invention, the material web 1 may be subjected to vacuum pressure from a number of vacuum rollers and each vacuum roller may apply a different amount of pressure so that each vacuum roller may be used to detect a different set of defect shapes and sizes. Alternatively, a single vacuum roller 3 may apply increasing amounts of vacuum pressure throughout the time period for which the material web 1 is in contact with the vacuum roller 3. By applying different vacuum pressures to the material web 1, defects 1b of different sizes can be detected, since each successive application of a vacuum pressure may be used to identify sets of defects 1b within a particular size/shape range.

In embodiments involving successive applications of vacuum pressure, it may be desirable to rewet the material web 1 between applications of vacuum pressure. Alternatively, successively higher vacuum pressures may be applied to the material web 1 so that defects 1b of different sizes can be detected without the material web 1 having to be rewetted. For example, in an embodiment of the invention, vacuum pressure may be applied to create a differential pressure of 20 mm Hg across the material web 1. Under this differential pressure, liquid 5 may be removed from defects 1b that are relatively large in size. The material web may then be placed in contact with a second vacuum roller capable of applying vacuum pressure to the material web 1 sufficient to create a differential pressure of 40 mm Hg across the material web 1. In this step, liquid 5 may be removed from smaller defects 1b.

In embodiments of the system and method intended for use in detecting defects in a dense film, only defects may be filled with liquid prior to the application of differential pressure. In such methods and systems, a differential pressure higher than the bubble point pressure of the defects may be applied to the dense film to draw the liquid from the defects.

In embodiments of the invention, defects 1b may be identified using a camera 6. The term “camera” means any image capturing device including, without limitation, a video camera, still camera, digital camera, charge-coupled device (CCD) camera, infrared camera or sensing array, etc. The camera 6 may capture an image of a portion of the material web 1 surface. The process of capturing an image may include preparing the image for storage on a computer readable medium by, for example, cropping a snapshot-type image to center around a particular target, editing a video clip to include only a portion of the frames taken by the camera, dividing the image into multiple pixels, and/or digitally editing the image to improve picture quality. For an image composed of multiple frames, the frame rate of image capture may differ from the frame rate at which the image or a portion thereof is replayed. For example, the frame rate of replay may be slower that the frame rate of capture.

The image (or a portion thereof) may be stored on an appropriate medium. For example, in an embodiment of the invention, an electronic image of the material web 1 surface may be captured using a digital camera and may be stored on a SmartMedia card, ClikStick, floppy disk, compact disk (CD), digital video disk (DVD), hard drive or other computer readable medium. The storage medium may be locally attached to the camera 6 or may be remotely connected to a communication network, such as, the Internet, a local area network (LAN), wide area network (WAN) or metropolitan area network (MAN), to which the camera 6 is also attached. In an embodiment of the present invention, the image may be transmitted in real-time from the camera 6 to a central server and stored therein.

In an embodiment in which the camera 6 captures an electronic image of the material web 1, the image may be transmitted to a central server using either wireless or wire-based communication channels. Examples of wire-based transmission include coaxial cable, twisted-pair telephone wire, electric power line, fiber optics, leased lines, and the like. Examples of wireless transmission include cellular, satellite, radio frequency, microwave, and like communication systems. In an embodiment in which the camera 6 captures a physical image of the signing event, the physical image may be converted to an electronic image using a document imaging device such as a scanner (not shown) and then transmitted to server. The central server may then store the electronic image in memory.

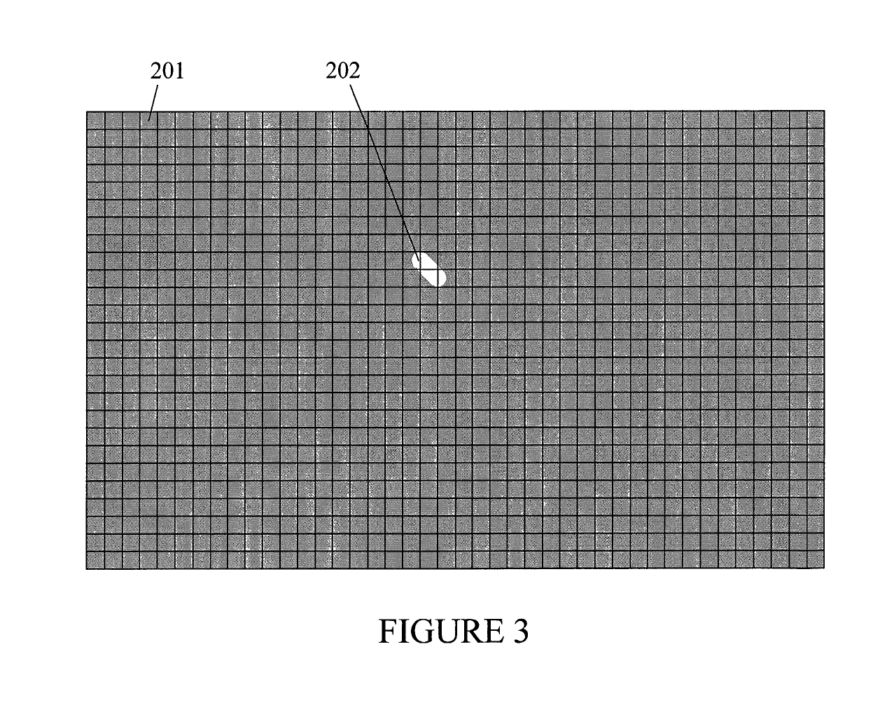

In embodiments of the invention, the camera 6 may be an infrared camera, such as the ThermaCam® line of thermal imaging cameras manufactured by FLIR Systems, Inc. of Portland, Oreg., which captures thermal images of portions of the surface of the material web 1 when the portions are in contact with the vacuum roller 3 or thereafter. FIG. 3 illustrates an example of a thermal image that may be captured by the camera 6 according to an embodiment of the invention. Although the thermal image in FIG. 3 is shown in black-and-white (using varying shades of gray), it should be understood that thermal images according to embodiments of the present invention may be in color.

In such embodiments, when vacuum pressure applied to the material web 1 draws liquid 5 from a defect 1b, air may also be drawn through the defect 1b by the vacuum pressure. If the temperature of the air drawn through the defect 1b differs from the temperature of the material web 1, the passing of the air through the defect 1b will cause convective cooling or heating (depending on whether the air is warmer or cooler than the material web 1) of the material web 1 material surrounding the defect 1b. This change in temperature may appear on a thermal image of the material web 1 surface as a discoloration. The convective cooling or heating effect may be accentuated by increasing the difference in temperature between the liquid 5 in the liquid bath 4 and the air drawn into the defects 1b by the vacuum pressure applied by the vacuum roller 3.

As shown in FIG. 3, the image may be pixelated and the pixelated image may be processed to identify the defects 1b through which air is being drawn by the vacuum roller 3, i.e., defects whose bubble point pressure has been exceeded. The processing may include making areas of discoloration 202 more prominent by locally increasing image contrast, associating the color(s) of a pixel(s) with a numerical value(s) for purposes of comparing one pixel 201 to another, aggregation of neighboring pixels 201, identification of sharp changes in pixel color (e.g., to identify color change boundaries), resizing of the image to compensate for capture angle, reweighting of pixel colors to account for known factors affecting thermal imagery (e.g., calibration of the camera 6 optics, known thermal patterns associated with convection from movement of the material web 1 or conduction by the vacuum roller 3, etc.) and the like. The pixel resolution of the image may be chosen based on the size of the pores 1a in the material web 1. For example, the pixel size may be chosen to be roughly equal to the size of an image of a single pore 1a.

Images of the material web 1 surface captured by the camera may be associated with information that may be used to determine the location of image features on the material web 1 surface. For example, in an embodiment of the invention, images may be time-stamped with information indicating when the image was captured. Information related to the speed and direction of travel of the material web 1 (e.g., the rotation speed of a driven roller) may also be stored. Based on the image's time of capture and the speed and direction of travel of the material web 1, the current location of a surface feature appearing in the captured image may be precisely calculated.

In alternative embodiments, the camera 6 may be a digital camera and the image captured may be either a color or black-and-white photographic image. The image may be pixelated and processed to compare one or more pixels 201 to known images associated with the drawing of air through defects 1b or known images of non-defective portions of the material web 1.

Note that while the prior discussion has focused on the use of a vacuum roller 3 to draw air into the defects 1b in the material web 1, in other embodiments of the invention, the vacuum roller 3 may be replaced with a roller which attempts to force air out through the defects 1b in the material web by supplying air at a given pressure to the surface of the material web 1 in contact with the roller. In such embodiments, the camera 6 may capture thermal images, and the temperature of the air forced out of the roller may be controlled to increase the contrast of the thermal image at points associated with the defects 1b. Alternatively in such embodiments, the camera 6 may capture photographic images, and portions of the image may be compared against known images of bubbles, examined for contours or shapes associated with bubbles and/or compared against known images of non-defective portions of the material web 1.

A commercially available or customized software package may be used to perform image data processing, produce output control signals, and the like. One such software package is LabView offered by National Instruments of Austin, Tex. The software package may receive input data related to an image of the material web 1 or a portion thereof and may process this data to determine whether a defect 1b can be identified. If such a defect can be identified, the software package may produce output data corresponding to the location of the identified defect, a control signal for repair equipment, and/or the like.

Movement of the material web 1 may be accomplished by driving the first roller 2a, the second roller 2b, the vacuum roller 3 or some combination thereof. The speed of movement of the material web 1 may depend upon the size and rotation speed of the driven roller(s). If multiple driven rollers are used, their rotation speeds may be matched so as not to apply excessive tension to the material web 1. In embodiments of the invention, the axles on which the first roller 2a, second roller 2b or vacuum roller 3 are mounted may be moved (e.g., within a slot) to apply a desired amount of tension to the material web 1.

A greater range of defects 1b may be identified in embodiments in which a greater range of differential pressures can be applied to the material web 1. The range of differential pressure that can be applied by an ideal vacuum roller is limited to the atmospheric pressure in which the vacuum roller is being operated. Therefore, to increase the range of applied differential pressures, in embodiments of the invention, the integrity testing described above may be performed within a pressure chamber with an increased atmospheric pressure.

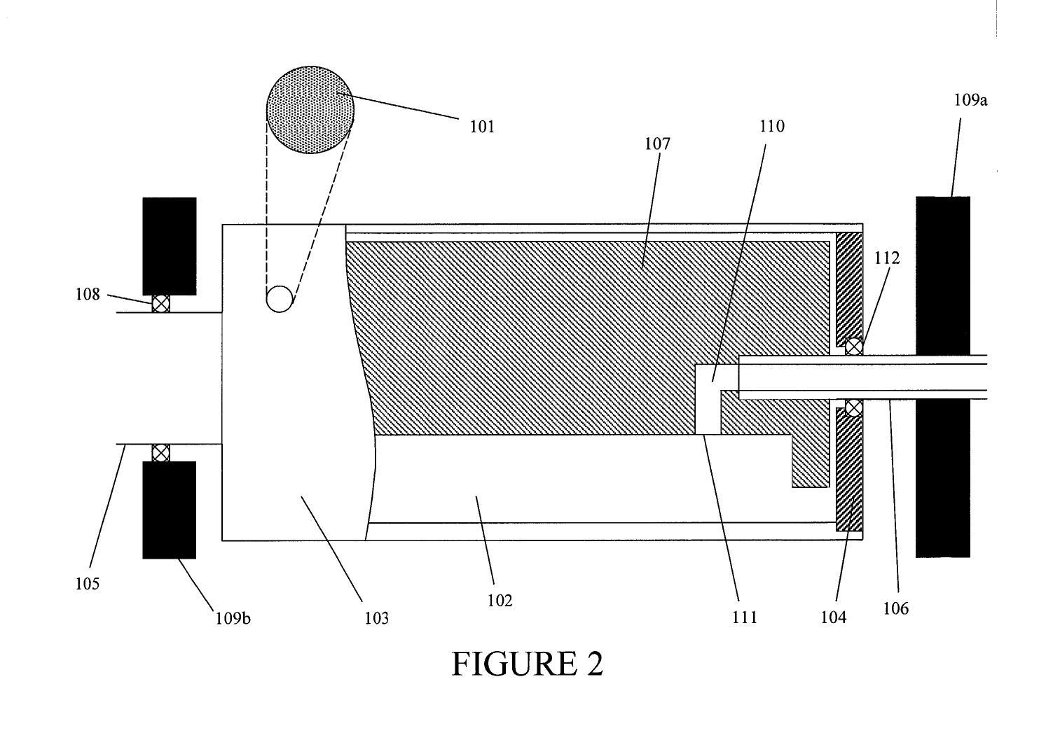

As shown in further detail in FIG. 2, in some embodiments, the vacuum roller 3 may include a cylindrical member 103 constructed of a porous material such as polypropylene or perforated stainless steel. The cylindrical member may rotate about an axle 105, which may be supported by one or more axle bearings 108 and fixed supports 109a. The outer surface of the cylindrical member 103 may be machined to a smoothness necessary to prevent the introduction of surface defects to the material web via contact with the outer surface of the cylindrical member 103. The cylindrical member 103 may have multiple openings 101 extending from its interior vacuum chamber 102 to the outer surface of the cylindrical member 103. The size of the openings 101 may affect the amount of vacuum pressure that can be produced by the vacuum roller. The openings 101 may be located uniformly throughout the cylindrical member 103 and some of these openings 101 may be blocked by a shield 107 so that only the openings 101 that are not blocked by the shield 107 transmit vacuum pressure from the interior vacuum chamber 102 to the outer surface of the cylindrical element 103. Alternatively, only a portion of the cylindrical element 103 may have the openings 101. The openings 101 need not be circular. In some embodiments, the openings in the cylindrical member 103 may take the shape of lateral channels. The size and pattern of the openings 101 may be selected to ensure that substantially all portions of the material web 1 are subjected to vacuum pressure. Alternatively, the size and pattern of openings 101 may be selected so that vacuum pressure is only applied to selected portions of the material web 1.

The amount of vacuum pressure applied to the material web 1 may be determined by the density of the material web 1, the feed rate of the material web 1, the size of openings 101 in the cylindrical element 103 of the vacuum roller 3, the strength of the vacuum source (such as a vacuum pump), the fluid properties of the liquid 5, the properties of the liquid-pore or liquid-defect interface, and other factors. The amount of vacuum pressure may be controlled to increase or decrease the differential pressure applied across the material web 1 so that defects 1b of a particular size may be identified.

Each of the lateral ends of the vacuum roller may be sealed with an end cap 104, which may act as a plug to seal the interior vacuum chamber 102. The suction source of a vacuum pump or other pump may be attached to a vacuum pressure inlet 106 so as to create a trans-web pressure differential across the pores 1a and defects 1b of the material web 1. In one embodiment, the one end of the vacuum pressure inlet 106 may connect to a vacuum pressure channel 110 that terminates at a channel opening 111. The vacuum pressure channel 110 may have one or more channel openings 111 to transmit vacuum pressure to the interior vacuum chamber 102. A inlet bearing 112 may separate the end cap 104 from the vacuum pressure inlet 106. Alternatively, a rotary coupling may be used.

The effective contact area between the material web 1 and the cylindrical element 103 of the vacuum roller 3 may be determined in part by the location of the first and second rollers 2a and 2b (see FIG. 1), the diameter of the vacuum roller 3, the size of the shield 107 and/or the percentage of openings 101 transmitting vacuum pressure at any instant, among other factors. The effective contact area between the material web 1 and the cylindrical element 103 of the vacuum roller 3 may be selected to ensure that the desired differential pressure is applied to the pores 1a and defects 1b of the material web 1 under steady-state conditions.

One or more of these factors may be changed in order to increase or decrease the effective contact area between the material web 1 and the cylindrical element 103 of the vacuum roller 3. For example, in embodiments of the system, the cylindrical member 103 and vacuum pressure inlet 106 of the vacuum roller 3 may be supported by mounts 109a and 109b. The position of the cylindrical member 103 and the vacuum pressure inlet 106 of the vacuum roller 3 may be raised or lowered relative to the mounts 109a and 109b so that more or less of the material web 1 is submerged in the flushing chemical 5. Alternatively, similar results may be accomplished by changing the configuration of the shield 7 so as to expose a greater or fewer number of openings 101 in the cylindrical member 103 of the vacuum roller 3, thereby applying vacuum pressure to a portion of the material web 1 for a longer or shorter period of time. In other embodiments of the invention, the effective contact area may be controlled by routing the material web around a series of roller assemblies, each of which may apply a different differential pressure across the material web 1.

One or more of the first positional roller 2a, the second positional roller 2b, and the vacuum roller 3 may be driven and the remaining rollers may be undriven. By controlling the rotational velocity of the driven roller(s), the feed rate and tension of the material web may be controlled. In embodiments of the invention, both the first and second positional rollers 2a and 2b may be driven and their speeds may be independently controlled. In such a system, if the tension on the flushed material web exceeds desired amounts, the speed of the second positional roller 2b may be reduced in relation to the speed of the first positional roller 2a.

In embodiments of the invention in which the liquid 5 is drained away after it has been drawn into the vacuum roller 3, the vacuum pressure inlet 106 may be positioned near the bottom of the cylindrical element 103 of the vacuum roller 3. The vacuum pressure inlet 106 material is preferably chosen to be chemically compatible with the liquid 5.

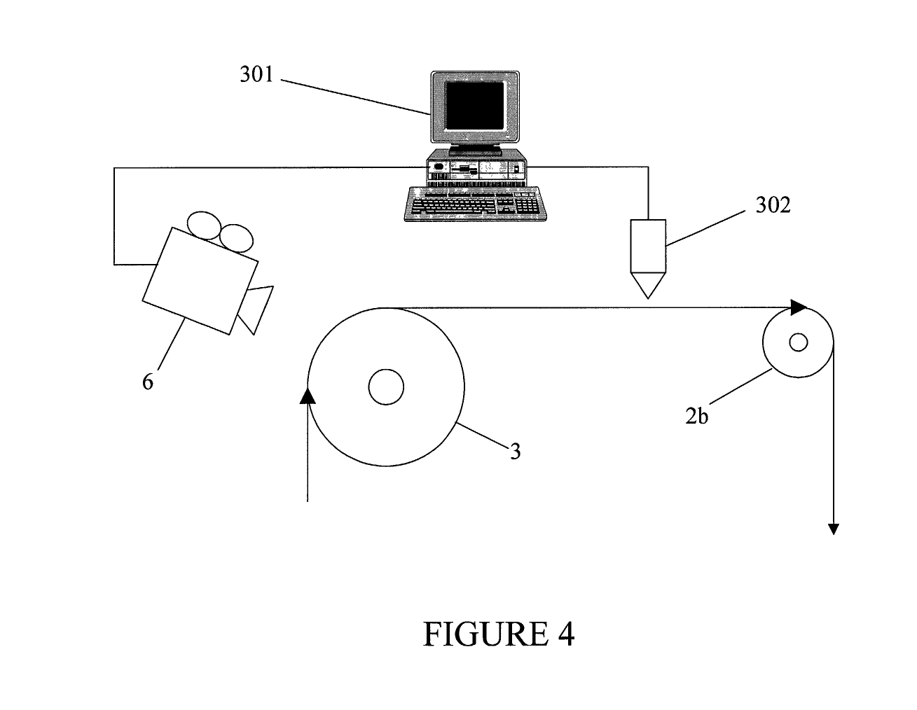

FIG. 4 shows a portion of an embodiment of the system in which the defects 1b in the material web 1 are marked or repaired (depending on the post-processing device 302 used) after the defects 1b have been identified. In embodiments of the present invention, the post-processing device may be a marker, such as an ink or dye dispenser, an etching device, or the like. When defects 1b in the material web 1 are identified, an area on the surface of the membrane corresponding to the identified defect 1b may be marked. For example, the area may be collocated with the defect 1b or may be near an edge of the material web 1 at a point laterally displaced from the location of the actual defect.

Alternatively, the post-processing device 302 may be a repair tool, such as a adhesive dispenser, a welding instrument, a soldering iron, a laser or the like. In embodiments of the invention in which the post-processing device 302 is a adhesive dispenser, the identified defect 1b may be repaired by covering the defect 1b with a bead of glue, resin, epoxy or a similar adhesive. The type of adhesive used may be chosen to suit the application for which the material web will later be used. The size of an adhesive bead deposited on the material web 1 may be chosen based upon the size and shape of the defect 1b. In alternative embodiments, the post-processing device 302 may be a diffusion, heat, arc or other type of welding apparatus. In such an embodiment, the post-processing device may place a piece of material over the defect 1b and weld the piece of material to the surface of the material web 1. The size and shape of the piece of material may be based on the size and shape of the defect 1b and, in particular embodiments of the invention, the piece of material may be cut from a larger material source based on the size and shape of the defect 1b.

To accomplish accurate marking or repair of defects 1b identified in the material web 1, the differential pressures at which various defects 1b in the material web 1 were identified may be recorded and associated with the identified defects. This information may be used to determine whether the defect 1b is of a shape and size amenable to repair and what reparatory action is appropriate. Moreover, the locations of various defects 1b may be calculated based on the images captured by the camera 6 and the speed and direction of travel of the material web 1. A processor 301, such as a computer or logic circuitry, may be used to calculate the location, size and/or shape of identified defects 1b.

The location of the post-processing device 302 may depend in part upon the processing speed of the processor, the time necessary to transmit signals from the camera 6 to the processor 301 and from the processor 301 to the post-processing device 302, and/or the speed and direction of travel of the material web 1. Data indicative of the location of the defect 1b to be transmitted by the processor 301 to the post-processing device 302 may include a two-axis coordinate pair corresponding to the location of the defect 1b in the plane of the material web 1, a time at which the defect will pass by the post-processing device 302 or some point related to the location of the post-processing device 302, a speed and direction according to which the post-processing device 302 should be moved to intercept the defect 1b, and the like.

While the embodiments particularly described above have generally focused on the use of a vacuum roller 3, in other embodiments of the invention, vacuum pressure may be applied to the material web using a vacuum belt, vacuum table or similar device. In an embodiment using a vacuum belt or vacuum table, the material web 1 may be held against the vacuum belt or vacuum table by vacuum pressure applied through openings in the vacuum belt or vacuum table. The material web 1 may travel in the same direction as the portion of the vacuum belt or vacuum table against which the material web 1 is being held. Such an embodiment may also be used with a material web 1 that is not continuous, e.g. in the form of pre-cut sheets.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A method for detecting a defect in a material web having a first surface, a second surface, and a pore, said defect having a defect bubble point pressure different from a pore bubble point pressure of said pore, the method comprising:
filling said pore and said defect with a liquid;
applying a differential pressure across said material web so as to remove said liquid from one of said pore and said defect, said differential pressure being between said defect bubble point pressure and said pore bubble point pressure;
capturing an image of said material web after said differential pressure has been applied, and
identifying said defect based on said image.

2. The method according to claim 1, wherein applying said differential pressure across said material web includes applying a vacuum pressure to said first surface of said material web.

3. The method according to claim 2, wherein applying vacuum pressure includes placing said material web in contact with a vacuum roller.

4. The method according to claim 1, wherein applying said differential pressure across said material web includes applying a gaseous pressure to said first surface of said material web.

5. The method according to claim 1, wherein said defect bubble point pressure is lower than said pore bubble point pressure and said liquid is removed from said defect.

6. The method according to claim 1, further including placing a mark on said material web.

7. The method according to claim 6, wherein said mark is placed over said defect.

8. The method according to claim 6, wherein said mark is placed near an edge of said material web.

9. The method according to claim 1, wherein identifying said defect includes comparing said image to a known image.

10. The method according to claim 1, wherein identifying said defect includes characterizing said image as a plurality of pixels.

11. The method according to claim 1, wherein removing said liquid from said one of said pore and said defect changes the temperature of a portion of said material web and further wherein said image is a thermal image of said material web.

12. The method according to claim 11, wherein identifying said defect includes characterizing said image as a plurality of pixels and assigning each of said pixels a numerical value based on a portion of said image corresponding to said pixel.

13. The method according to claim 11, wherein said second surface of said material web is in contact with a gas, wherein said gas is of a different temperature than said liquid, and wherein removing said liquid from said one of said pore and said defect includes drawing said gas into said one of said pore and said defect.

14. The method according to claim 1, further including calculating a current location of said defect based on information related to the velocity of said material web.

15. The method according to claim 1, further including applying a second differential pressure across said material web and capturing a second image of said material web after said second differential pressure has been applied.

16. A method for detecting a defect in a continuous material web having a pore and a defect, said method comprising:
filling said pore and said defect with a liquid;
placing a portion of said continuous material web in contact with a differential pressure source;
applying vacuum pressure to said continuous material web to create a differential pressure across said portion of said continuous material web, said differential pressure being higher than the bubble point pressure for said defect and lower than the bubble point pressure for said pore;
capturing an image of said portion of said continuous material web after said differential pressure has been applied; and
identifying said defect based on said image.

17. A system for detecting a defect in a material web, said material web having a first surface, a second surface, and a pore, said defect having a defect bubble point pressure different that a pore bubble point pressure of said pore, said system comprising:
a differential pressure source in contact with said first surface of said material web configured to apply a differential pressure across said material web, said;
a liquid contained within said pore and said defect;
a camera configured to capture an image of a portion of said material web after said differential pressure has been applied across said material web; and
a processor configured to determine the location of said defect based on said image, wherein
said differential pressure is between said defect bubble point pressure and said pore bubble point pressure such that, when said differential pressure is applied across said material web, said liquid is removed from one of said pore and said defect.

18. The system according to claim 17, wherein said processor is configured to receive data related to said image and to identify a portion of said image corresponding to said defect based on said data.

19. The system according to claim 17, wherein said processor includes logic for determining a current location of said defect on said material web based on data related to a location within said image of a portion of said image showing said defect and data related to at least one of a speed and a direction of travel of said material web.

20. The system according to claim 19, further including a post-processing device configured to receive data related to the current location of said defect from said processor and further configured to mark the current location of said device on said material web.

21. The system according to claim 20, wherein said post-processing device is configured so that it may be moved into contact with the material web.

22. The system according to claim 17, wherein said camera captures a thermal image of said portion of said material web.

23. The system according to claim 22, wherein said camera is an infrared camera.

24. The system according to claim 22, wherein a gas of a different temperature than said liquid is drawn into said one of said pore and said defect and said drawing said gas into said one of said pore and said defect changes the temperature of a portion of said material web surrounding said one of said pore and said defect.

25. The system according to claim 17, wherein said camera captures a photographic image of said portion of said material web.

26. The system according to claim 25, wherein said photographic image is a color photographic image.

27. The system according to claim 17, further including a first roller.

28. The system according to claim 27, wherein said first roller is configured such that said portion of said material web is submerged in said liquid when said portion of said material web is in contact with said first roller.

29. The system according to claim 27, further including a second roller.

30. The system according to claim 29, wherein at least one of said first roller and said second roller is driven.

31. The system according to claim 17, wherein said differential pressure source is configured to apply a second differential pressure across said material web.

32. The system according to claim 31, wherein said camera is configured to capture a second image of said portion of said material web after said second differential pressure has been applied.

33. The system according to claim 17, wherein said differential pressure source is a vacuum roller having a vacuum pressure inlet, an interior vacuum chamber and a cylindrical element with an opening therethrough, and said system further including a vacuum pressure source connected to said vacuum pressure inlet.

34. The system according to claim 33, wherein said cylindrical element rotates through a rotational cycle, and said vacuum roller further includes a shield, said shield and said inner surface of said cylindrical member being configured so to substantially enclose said interior vacuum chamber.

35. The system according to claim 33, wherein said cylindrical element has a plurality of openings therethrough.

36. The system according to claim 17, wherein said differential pressure source applies pressurized gas to said first surface of said material web.

37. The system according to claim 36, wherein said differential pressure source changes the temperature of said pressurized gas prior to applying it to said first surface of said material web.

38. The system according to claim 17, wherein a bubble of gas encased in said liquid is produced on one of said first surface and said second surface of said material web at a location corresponding to said defect when said differential pressure is applied across said material web.

39. The system according to claim 38, wherein said image includes an image of said bubble and said processor is configured to compare data related to an image of said bubble with data related to a known image of a bubble.

40. The system according to claim 17, further including a liquid bath containing said liquid, wherein a portion of said material web is submerged in said liquid bath such that said liquid enters said pore and said defect.

41. A system for detecting a defect in a material web, said material web having a first surface, a second surface, and a pore, said defect having a defect bubble point pressure different than a pore bubble point pressure of said pore, said system comprising:
a vacuum roller in contact with said first surface of said material web, said vacuum roller configured to apply a differential pressure across said material web;
a liquid bath containing a liquid, wherein a portion of said material web is submerged in said liquid bath such that said liquid enters said pore and said defect; and
a camera to capture a thermal image of a portion of said material web after said differential pressure has been applied across said material web; and
a processor to determine the location of said defect based on said image, wherein
said differential pressure is between said defect bubble point pressure and said pore bubble point pressure such that, when said differential pressure is applied across said material web, said liquid is removed from one of said pore and said defect, and
the temperature of a portion of said material web proximate said defect changes when said liquid is removed from said defect.

42. A method for repairing a defect in a material web having a first surface, a second surface, and a pore, said defect having a defect bubble point pressure different from a pore bubble point pressure of said pore, the method comprising:
filling said pore and said defect with a liquid;
applying a differential pressure across said material web so as to remove said liquid from one of said pore and said defect, said differential pressure being between said defect bubble point pressure and said pore bubble point pressure;
capturing an image of said material web after said differential pressure has been applied,
identifying said defect based on said image;
calculating a current location of said defect;
transmitting data relating to said current location to a post-processing device; and
causing a post-processing device to effect a repair at said current location of said defect.

43. The method according to claim 42, further including determining at least one of the size and the shape of said defect, and transmitting data related to said at least one of said size and said shape to said post-processing device.

44. The method according to claim 42, wherein causing said post-processing device to effect a repair includes causing said post-processing device to move into contact with said material web.

45. The method according to claim 42, wherein said post-processing device is an adhesive dispenser, and wherein causing said post-processing device to effect a repair includes causing said adhesive dispenser to dispense a bead of an adhesive to cover at least a portion of said defect.

46. The method according to claim 42, wherein causing said post-processing device to effect a repair includes causing said post-processing device to affix a piece of a material to said material web to cover said defect.

47. The method according to claim 42, wherein causing said post-processing device to effect a repair includes causing said post-processing device to heat a portion of said material web proximate to said defect.

48. A system for repairing a defect in a material web, said material web having a first surface, a second surface, and a pore, said defect having a defect bubble point pressure different than a pore bubble point pressure of said pore, said system comprising:
a differential pressure source in contact with said first surface of said material web, said differential pressure source configured to apply a differential pressure across said material web;
a liquid bath containing a liquid, wherein a portion of said material web is submerged in said liquid bath such that said liquid enters said pore and said defect; and
a camera to capture an image of a portion of said material web after said differential pressure has been applied across said material web; and
a processor to determine a location of said defect based on said image; and
a post-processing device to receive data related to the location of said defect and to effect a repair; wherein
said differential pressure is between said defect bubble point pressure and said pore bubble point pressure such that when said differential pressure is applied across said material web, said liquid is removed from one of said pore and said defect.

49. The method according to claim 48, wherein said processor is further configured to determine at least one of the size and the shape of said defect, and to transmit data related to said at least one of said size and said shape to said post-processing device.

50. The method according to claim 48, wherein said post-processing device is configured to move into contact with said material web when effecting a repair.

51. The method according to claim 48, wherein said post-processing device is an adhesive dispenser, configured to dispense a bead of an adhesive to cover at least a portion of said defect.

52. The method according to claim 48, wherein said post-processing is configured to affix a piece of a material to said material web to cover said defect.

53. The method according to claim 48, wherein said post-processing device is configured to heat a portion of said material web proximate to said defect.

54. A method for detecting a defect in a material web having a first surface and a second surface, said defect having a defect bubble point pressure, the method comprising:
filling said defect with a liquid;
applying a differential pressure across said material web so as to remove said liquid from said defect, said differential pressure exceeding said defect bubble point pressure;
capturing an image of said material web after said differential pressure has been applied, and
identifying said defect based on said image.

55. The method according to claim 54, wherein applying said differential pressure across said material web includes applying a vacuum pressure to said first surface of said material web.

56. The method according to claim 55, wherein applying vacuum pressure includes placing said material web in contact with a vacuum roller.

57. The method according to claim 54, wherein applying said differential pressure across said material web includes applying a gaseous pressure to said first surface of said material web.

58. The method according to claim 54, further including placing a mark on said material web.

59. The method according to claim 58, wherein said mark is placed over said defect.

60. The method according to claim 58, wherein said mark is placed near an edge of said material web.

61. The method according to claim 54, wherein identifying said defect includes comparing said image to a known image.

62. The method according to claim 54, wherein identifying said defect includes characterizing said image as a plurality of pixels.

63. The method according to claim 54, wherein removing said liquid from said one of said pore and said defect changes the temperature of a portion of said material web and further wherein said image is a thermal image of said material web.

64. The method according to claim 63, wherein identifying said defect includes characterizing said image as a plurality of pixels and assigning each of said pixels a numerical value based on a portion of said image corresponding to said pixel.

65. The method according to claim 63, wherein said second surface of said material web is in contact with a gas, wherein said gas is of a different temperature than said liquid, and wherein removing said liquid from said one of said pore and said defect includes drawing said gas into said one of said pore and said defect.

66. The method according to claim 54, further including calculating a current location of said defect based on information related to the velocity of said material web.

67. The method according to claim 54, further including applying a second differential pressure across said material web and capturing a second image of said material web after said second differential pressure has been applied.

68. The method according to claim 54, wherein the material web is one of a dense film, a non-woven mat and a porous membrane.

69. A system for detecting a defect in a material web, said material web having a first surface and a second surface, said defect having a defect bubble point pressure, said system comprising:
a differential pressure source in contact with said first surface of said material web configured to apply a differential pressure across said material web, said;
a liquid contained within said defect;
a camera configured to capture an image of a portion of said material web after said differential pressure has been applied across said material web; and
a processor configured to determine the location of said defect based on said image, wherein
said differential pressure exceeds said defect bubble point pressure such that, when said differential pressure is applied across said material web, said liquid is removed from said defect.

70. The system according to claim 69, wherein said processor is configured to receive data related to said image and to identify a portion of said image corresponding to said defect based on said data.

71. The system according to claim 69, wherein said processor includes logic for determining a current location of said defect on said material web based on data related to a location within said image of a portion of said image showing said defect and data related to at least one of a speed and a direction of travel of said material web.

72. The system according to claim 71, further including a post-processing device configured to receive data related to the current location of said defect from said processor and further configured to mark the current location of said device on said material web.

73. The system according to claim 72, wherein said post-processing device is configured so that it may be moved into contact with the material web.

74. The system according to claim 69, wherein said camera captures a thermal image of said portion of said material web.

75. The system according to claim 74, wherein said camera is an infrared camera.

76. The system according to claim 74, wherein a gas of a different temperature than said liquid is drawn into said one of said pore and said defect and said drawing said gas into said one of said pore and said defect changes the temperature of a portion of said material web surrounding said one of said pore and said defect.

77. The system according to claim 69, wherein said camera captures a photographic image of said portion of said material web.

78. The system according to claim 77, wherein said photographic image is a color photographic image.

79. The system according to claim 69, further including a first roller.

80. The system according to claim 79, wherein said first roller is configured such that said portion of said material web is submerged in said liquid when said portion of said material web is in contact with said first roller.

81. The system according to claim 79, further including a second roller.

82. The system according to claim 81, wherein at least one of said first roller and said second roller is driven.

83. The system according to claim 69, wherein said differential pressure source is configured to apply a second differential pressure across said material web.

84. The system according to claim 83, wherein said camera is configured to capture a second image of said portion of said material web after said second differential pressure has been applied.

85. The system according to claim 69, wherein said differential pressure source is a vacuum roller having a vacuum pressure inlet, an interior vacuum chamber and a cylindrical element with an opening therethrough, and said system further including a vacuum pressure source connected to said vacuum pressure inlet.

86. The system according to claim 85, wherein said cylindrical element rotates through a rotational cycle, and said vacuum roller further includes a shield, said shield and said inner surface of said cylindrical member being configured so to substantially enclose said interior vacuum chamber.

87. The system according to claim 85, wherein said cylindrical element has a plurality of openings therethrough.

88. The system according to claim 69, wherein said differential pressure source applies pressurized gas to said first surface of said material web.

89. The system according to claim 88, wherein said differential pressure source changes the temperature of said pressurized gas prior to applying it to said first surface of said material web.

90. The system according to claim 69, wherein a bubble of gas encased in said liquid is produced on one of said first surface and said second surface of said material web at a location corresponding to said defect when said differential pressure is applied across said material web.

91. The system according to claim 90, wherein said image includes an image of said bubble and said processor is configured to compare data related to an image of said bubble with data related to a known image of a bubble.

92. The system according to claim 69, further including a liquid bath containing said liquid, wherein a portion of said material web is submerged in said liquid bath such that said liquid enters said pore and said defect.

93. A method for repairing a defect in a material web having a first surface and a second surface, said defect having a defect bubble point pressure, the method comprising:
filling said defect with a liquid;
applying a differential pressure across said material web so as to remove said liquid from said defect, said differential pressure exceeding said defect bubble point pressure;
capturing an image of said material web after said differential pressure has been applied,
identifying said defect based on said image;
calculating a current location of said defect;
transmitting data relating to said current location to a post-processing device; and
causing a post-processing device to effect a repair at said current location of said defect.

94. The method according to claim 93, further including determining at least one of the size and the shape of said defect, and transmitting data related to said at least one of said size and said shape to said post-processing device.

95. The method according to claim 93, wherein causing said post-processing device to effect a repair includes causing said post-processing device to move into contact with said material web.

96. The method according to claim 93, wherein said post-processing device is an adhesive dispenser, and wherein causing said post-processing device to effect a repair includes causing said adhesive dispenser to dispense a bead of an adhesive to cover at least a portion of said defect.

97. The method according to claim 93, wherein causing said post-processing device to effect a repair includes causing said post-processing device to affix a piece of a material to said material web to cover said defect.

98. The method according to claim 93, wherein causing said post-processing device to effect a repair includes causing said post-processing device to heat a portion of said material web proximate to said defect.

99. A system for repairing a defect in a material web, said material web having a first surface and a second surface, said defect having a defect bubble point pressure, said system comprising:
a differential pressure source in contact with said first surface of said material web, said differential pressure source configured to apply a differential pressure across said material web;
a liquid bath containing a liquid, wherein a portion of said material web is submerged in said liquid bath such that said liquid enters said defect; and
a camera to capture an image of a portion of said material web after said differential pressure has been applied across said material web; and
a processor to determine a location of said defect based on said image; and
a post-processing device to receive data related to the location of said defect and to effect a repair; wherein
said differential pressure exceeds said defect bubble point pressure such that when said differential pressure is applied across said material web, said liquid is removed from one of said defect.

100. The method according to claim 99, wherein said processor is further configured to determine at least one of the size and the shape of said defect, and to transmit data related to said at least one of said size and said shape to said post-processing device.

101. The method according to claim 99, wherein said post-processing device is configured to move into contact with said material web when effecting a repair.

102. The method according to claim 99, wherein said post-processing device is an adhesive dispenser, configured to dispense a bead of an adhesive to cover at least a portion of said defect.

103. The method according to claim 99, wherein said post-processing is configured to affix a piece of a material to said material web to cover said defect.

104. The method according to claim 99, wherein said post-processing device is configured to heat a portion of said material web proximate to said defect.
